(19) United States
(12) Patent Application Publication
(10) Pub. No.: US 2006/0248800 A1
(43) Pub. Date: Nov. 9, 2006

(54) Apparatus and process for production of high purity hydrogen

(76) Inventors: Maria Therese Miglin, Katy, TX (US); Lloyd Anthony Clomburg JR., Houston, TX (US); Glenn William Elliott, Sugar Land, TX (US); Michiel Jan Groeneveld, Rijswijk (NL); Rong-Her Jean, Sugar Land, TX (US); Andreas Nicholas Matzakos, Missouri City, TX (US); Abdul Wahid Munshi, Houston, TX (US); Peter Veenstra, Sugar Land, TX (US); Scott Lee Wellington, Bellaire, TX (US)

Correspondence Address: SHELL OIL COMPANY, P O BOX 2463, HOUSTON, TX, 772522463, US

(21) Appl. No.: 10/526,915

(22) PCT Filed: Sep. 5, 2003
(86) PCT No.: PCT/US03/27995

§ 371 Date: Jul. 1, 2005

Related U.S. Application Data
(60) Provisional application No. 60/408,427, filed on Sep. 5, 2002.

(51) Int. Cl. B01J 8/00

(52) U.S. Cl. 48/198.7; 423/648.1; 48/127.9; 48/198.1; 48/198.3

(57) ABSTRACT

The invention relates to a new and improved process and apparatus for the production of high purity hydrogen by steam reforming. The apparatus is an integrated flameless distributed combustion-membrane steam reforming (FDC-MSR) or reactor for steam reforming of a vaporizable hydrocarbon to produce H₂ and CO₂, with minimal CO, and minimal CO in the H₂ stream. The flameless distributed combustion drives the steam reforming reaction which pro-vides great improvements in heat exchange efficiency and load following capabilities. The reactor may contain multiple flameless distributed combustion chambers and multiple hydrogen-selective, hydrogen-permeable, membrane tubes. The feed and reaction gases may flow through the reactor either radially or axially. A further embodiment of the invention involves producing high purity hydrogen by dehydrogenation using an integrated FDC-membrane de-hydrogenation reactor. A still further embodiment of the invention involves a zero emission hybrid power system wherein the produced hydrogen is used to power a high-pressure internally manifolded molten carbonate fuel cell. In addition, the design of the FDC-SMR powered fuel cell makes it possible to capture good concentrations of CO₂ for sequestration or use in other processes.

### FIELD OF THE INVENTION

This invention relates to a process and apparatus for the production of high purity hydrogen by steam reforming, to the separation of hydrogen produced therefrom, and to the use of the hydrogen in a zero emission hybrid power system incorporating a fuel cell.

### BACKGROUND OF THE INVENTION

The production of electrical power in the most efficient manner with minimization of waste is the focus of much research. It would be desirable to improve efficiency in the production of electricity, separate and use by-product CO₂ in other processes, and produce minimal NOₓ. The wide availability of natural gas with the highest H:C ratio (4:1) of any fossil fuel makes it a prime candidate for electricity production with minimum CO₂ emissions.

Electricity can be produced in fuel cells using pure hydrogen. Hydrogen production is commercially proven, but expensive. One method of producing hydrogen is steam methane reforming where hydrocarbons and water are reacted to form CO and H₂, followed by a separate water-gas-shift reaction where CO is reacted with H₂O to form CO₂ and H₂. The commercial application of these reactions in many refineries commonly involves a series of reactors including a steam reforming reactor, and several post reactors to address the production of CO in the reformer. The post reactors include a high temperature shift reactor, a low temperature shift reactor, and a CO₂ absorber separator. Water and CO₂ separation is necessary to achieve pure hydrogen. The reforming reactor is run at high pressure to avoid hydrogen recompression downstream. The pressure lowers the equilibrium conversion since reforming produces a positive net mole change. The steam reforming reaction is very endothermic; and the shift reaction is also exothermic. The conventional steam reforming reactors are operated above 900° C. to push the equilibrium toward complete formation of CO and H₂. The high temperature causes severe corrosion and stress problems on the equipment. Steam reforming reactors are generally large to accomplish economies of scale. In addition, the typical operation of the shift reactor at a lower temperature than the reforming reactor makes it impractical to combine these two chemical reactions in one reactor. Furthermore, designs currently known do not lend themselves to being scaled down to a smaller size or to making it possible to efficiently control the temperature at various points.

Even if a reactor was capable of producing only CO₂ and H₂ and the conventional post reactors could be eliminated, the issue of CO₂ separation would remain.

It would be desirable in the art to provide a steam reformer reactor design for producing hydrogen substantially free of carbon and carbon oxides and with minimal production of NOₓ. If the high purity hydrogen produced could be used to create power in a hybrid system that could be compact in design and provide greater efficiency, such as more than 71%, in the production of energy it would represent a distinct advance in the art. In addition, it would be desirable if lower temperatures could be used and if the entire process permitted more control over temperatures at various points, or load-following capabilities. It would also be desirable to provide the modularity needed at bulk-hydrogen production scales so that a producer can match the desired capacity by installing multiple reactor units of the specific design. This is more cost-effective than either trying to scale up or down the existing large box furnace reactor designs or building several thousand single-tube reactors. It would also be desirable to employ less volume than conventional processes by intensifying the process and using less catalyst and smaller heater space. Furthermore, if the process produced CO₂ in higher concentrations and greater purity than other processes in the art, and the CO₂ could be sequestered for other uses, it would be extremely desirable. Such an integrated system would demonstrate far greater efficiency than any power generating system currently available.

### SUMMARY OF THE INVENTION

The invention relates to an improved process and apparatus for the production of high purity hydrogen by steam reforming. The apparatus is an integrated flameless distributed combustion-membrane steam reforming (FDC-MSR) reactor for steam reforming of a vaporizable hydrocarbon to produce H₂ and CO₂, with minimal CO as end product, and minimal concentration of CO in the H₂ stream. The reactor may contain multiple flameless distributed combustion chambers and multiple hydrogen-selective, hydrogen-permeable, membrane tubes. The feed and reaction gases may flow through the reactor either radially or axially. A further embodiment of the invention involves an integrated flameless distributed combustion membrane dehydrogenation reactor for dehydrogenation of a hydrocarbon-containing compound, such as ethyl benzene, to form hydrogen. A still further embodiment of the invention involves a zero emission hybrid power system wherein the produced hydrogen is used to power a high-pressure internally manifolded molten carbonate fuel cell. In addition, the design of the FDC-SMR powered fuel cell makes it possible to capture good concentrations of CO₂ for sequestration or use in other processes such as for enhanced oil recovery.

### BRIEF DESCRIPTION OF THE DRAWINGS

FIG. 1 is a schematic diagram of the novel membrane steam-reforming (MSR) reactor with a flameless distributed combustion (FDC) heater section, catalyst section, and permeate section placed in order from the outside in.

FIG. 2 is a schematic diagram of another embodiment of the novel FDC-MRS reactor of the invention.

FIG. 3 is a graph showing molar fraction and methane conversion along the reactor.

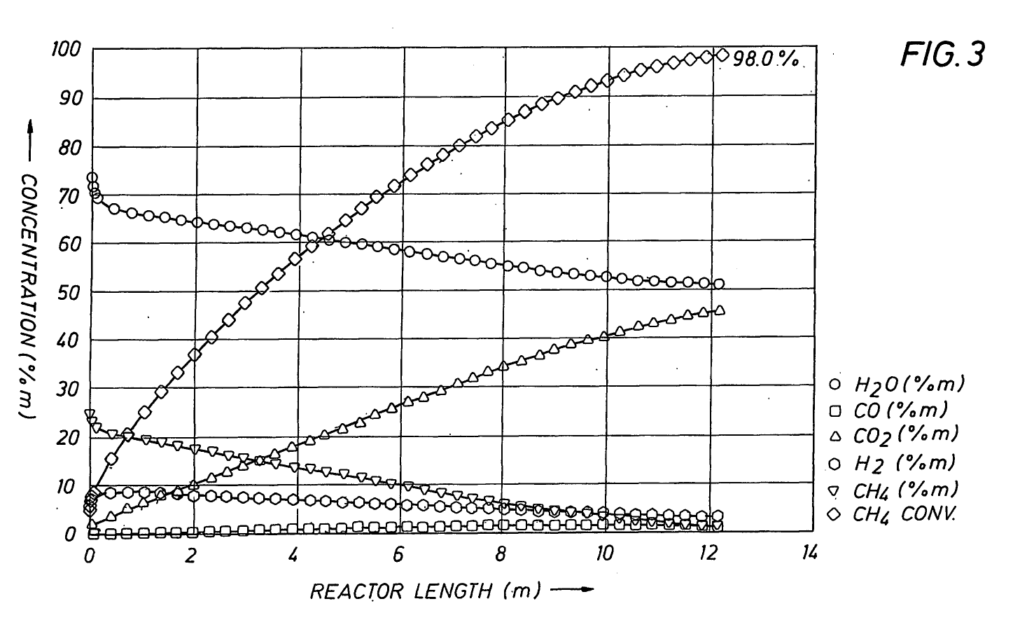

FIG. 4 is a graph showing temperature and heat flux per length profile along the reactor.

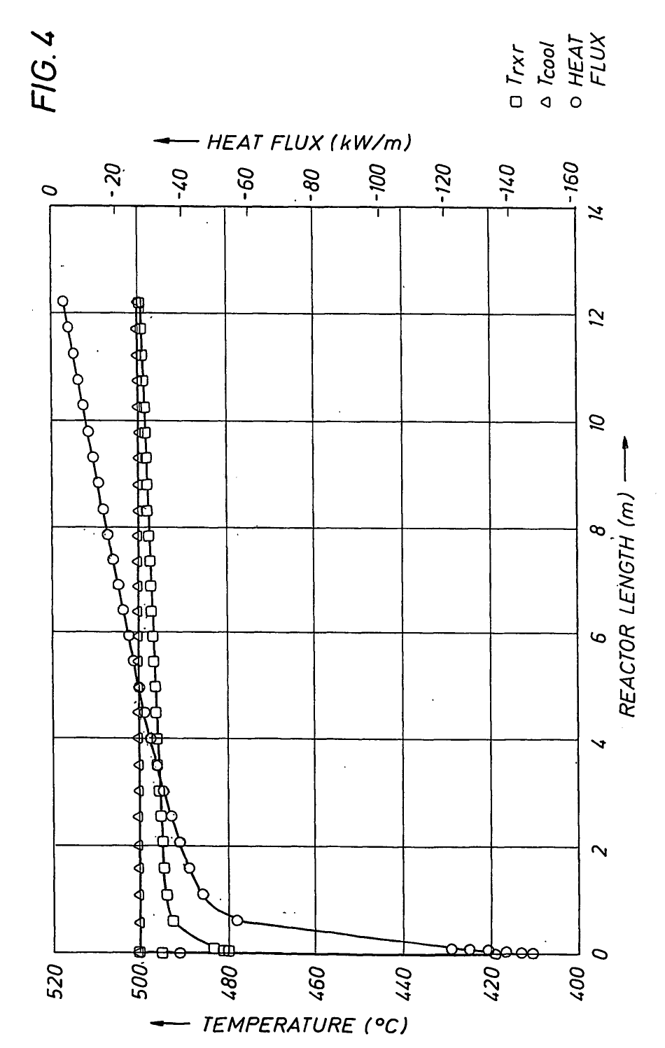

FIG. 5 is a graph showing hydrogen molar fraction profile and membrane volumetric flux per length (in m³/m/s) along the reactor.

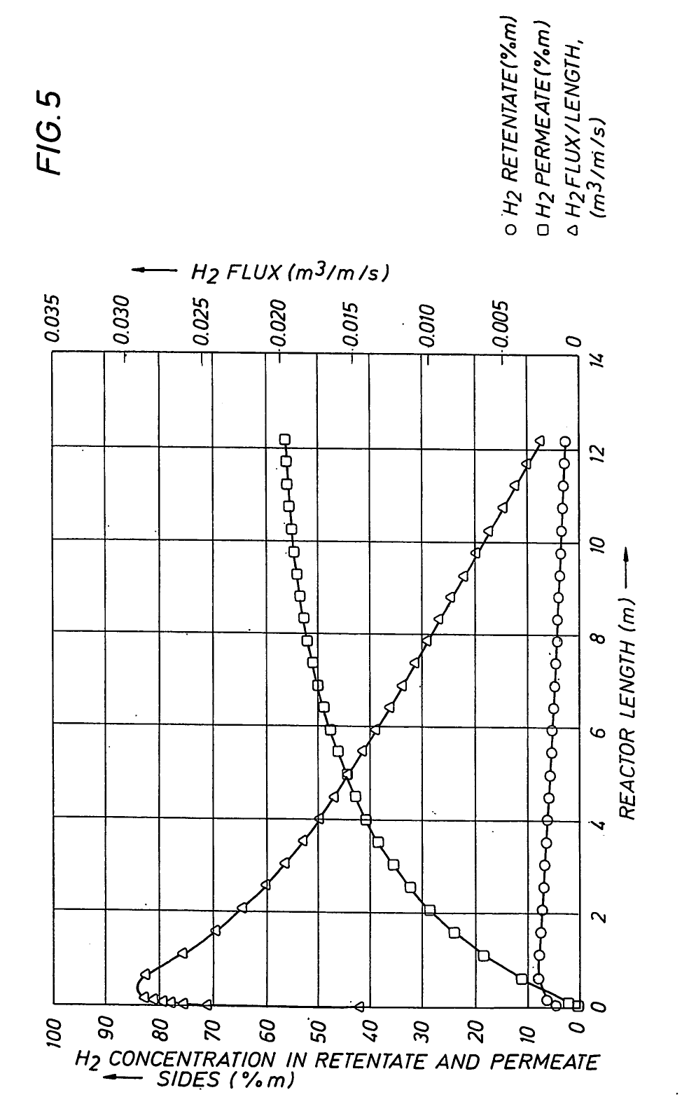

FIG. 6 is a simplified flow diagram of the zero emission flameless distributed combustion membrane steam reformer fuel hybrid power system.

FIGS. 7A&B is a process flow diagram of the zero emission process as simulated in a HYSYS process simulator.

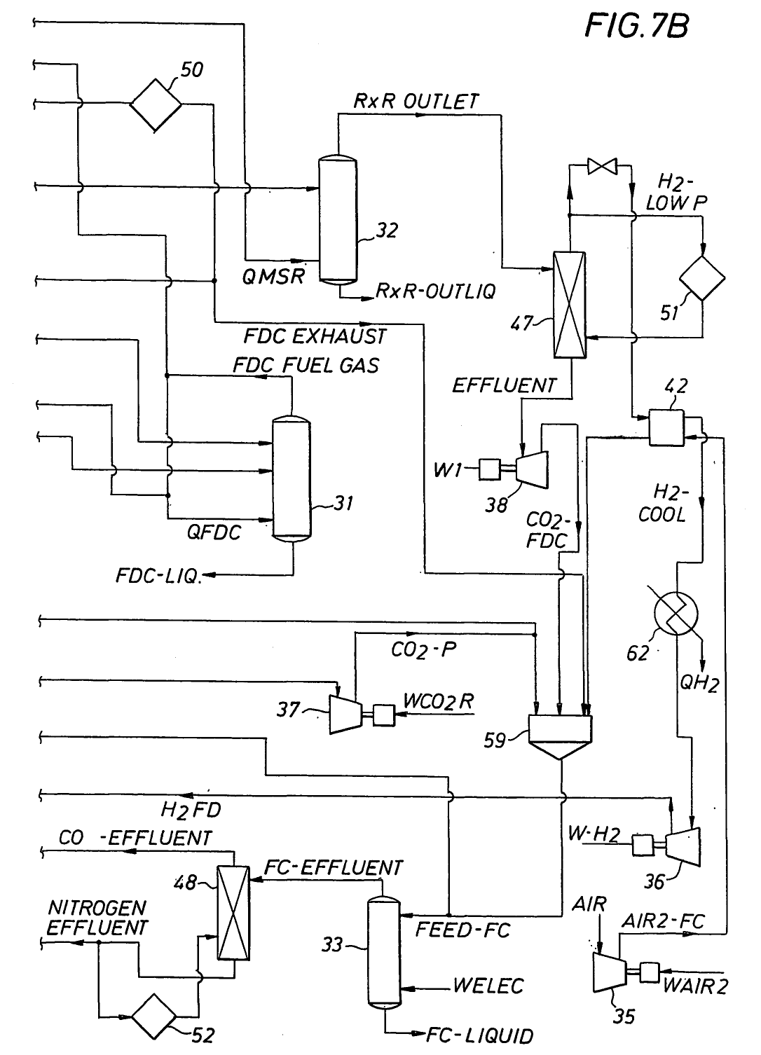

FIG. 8 is a schematic diagram of a multi-tubular, FDC heated, radial flow, membrane, steam reforming reactor in accordance with the invention. Some of the inlet and outlet streams of the membrane and FDC tubes have been omitted for simplicity.

FIG. 9 is a cross section of the shell of the multi-tubular, FDC heated, radial flow, membrane reactor shown in FIG. 8.

FIGS. 10A and 10B are schematic diagrams of a “closed ended” and of an “open ended” FDC tubular chamber used to drive the reforming reactions in the process and apparatus of the present invention.

FIG. 11 is a schematic diagram of a multi-tubular, FDC heated, axial flow, membrane steam reforming reactor in accordance with the invention.

FIGS. 12 is a cross section of the shell of the Multi-tubular, FDC heated, axial flow, membrane reactor shown in FIG. 11.

FIGS. 13A & 13B and 13C & 13D are schematic diagrams of two baffle configurations which can be employed to increase the contact of the reactant gases with the catalyst in a multi-tubular, FDC-heated, axial flow, membrane reactor in accordance with the invention.

FIGS. 14, 15 16 and 17 are top cross section views of the shells of other embodiments of the multi-tubular, FDC heated, axial flow, membrane, steam reforming reactors of the invention.

### DETAILED DESCRIPTION OF THE INVENTION

The present invention provides a new process and apparatus for steam reforming of any vaporizable hydrocarbon to produce H₂ and CO₂, with minimal CO as endproduct, and having minimum concentration of CO in the H₂ stream, said process being accomplished in one reactor, at lower temperatures than those used in conventional steam methane reforming reactors, constantly removing pure hydrogen, and using as a heat source flameless distributed combustion which provides great improvements in heat exchange efficiency and load-following capabilities to drive the steam reforming reaction. Similar efficiency and load-following is simply not possible with conventional firebox steam reformer furnace designs and multi-reactor shift units. The flameless distributed combustion heat source makes it possible to transfer between 90 and 95% of the heat to the reacting fluids. In another embodiment, the invention is also a zero emission hybrid power system wherein the produced hydrogen is used to power a high-drogen is used to power a high-pressure internally or externally manifolded molten carbonate fuel cell. The system is capable of achieving 71% or greater efficiency in the conversion of fuel to electricity. In addition, the design of this flameless distributed combustion—membrane steam reforming reactor (FDC-MSR) fueled hybrid system makes it possible to capture high concentrations of CO₂ for sequestration or use in other processes. Finally, the design of the system can be scaled down to a mobile, lightweight unit.

Moreover, at bulk-hydrogen production scales, the multi-tubular (multiple FDC tubes and multiple hydrogen selective and permeable membrane tubes) containing reactor disclosed herein provides the modularity needed. A producer can match the desired capacity by installing multiple reactor units of the specific design or having multiple FDC tubes and/or multiple hydrogen selective and permeable membrane units in a large steam reformer. This is more cost-effective than either trying to scale up or down the existing large box furnace reactor designs or building several thousand single-tube reactors.

The process for steam reforming of any vaporizable hydrocarbon to produce purified H₂ and CO₂ comprises:
a) Providing a generally tubular reforming chamber having one or more inlets for vaporizable hydrocarbons and steam, and one or more corresponding outlets for byproduct gases, including H₂O and CO₂, with a flow path in between said inlet and outlet, and
having one or more inlets for sweep gas (which may be H₂O in the form of steam, or other gas such as recycled CO₂, nitrogen or condensable hydrocarbons) and corresponding outlets for the sweep gas and hydrogen, with a flow path between said inlet and outlet, and
having one or more inlets for preheated air and corresponding inlets for fuel gas mixtures, with a flow path between said inlets containing at least one, particularly plurality of flameless distributed combustion heaters,

wherein said flow path for vaporizable hydrocarbon and flow path for sweep gas form two concentric sections with an annulus between having a reforming catalyst therein;

b) Feeding a vaporizable hydrocarbon and steam into said reforming chamber through said inlet for a vaporizable hydrocarbon and steam;

c) Flowing said vaporizable hydrocarbon over a reforming catalyst;

d) Causing both steam reforming-and the shift reaction to take place in said reforming chamber; and

e) Conducting said reforming in the vicinity of at least one hydrogen-permeable and hydrogen-selective membrane, whereby pure hydrogen permeates said membrane;

f) Wherein heat to drive said reaction is provided by said flameless distributed combustors.

The process of the present invention may also be described as a process for the production of hydrogen, comprising:
a) reacting steam with a vaporizable hydrocarbon at a temperature of from about 200° C. to about 700° C. and at a pressure of from about 1 bar to about 200 bar in a reaction zone containing reforming catalyst to produce a mixture of primarily hydrogen and carbon dioxide, with a lesser amount of carbon monoxide;
b) providing heat to said reaction zone by employing one or more flameless distributed combustion chambers (which may in the form of a tube or other shape) thereby driving said reaction;
c) conducting said reaction in the vicinity of one or more hydrogen-permeable and hydrogen-selective membranes, which may be in the form of a tube or others, whereby hydrogen formed in said reaction zone permeates through said selective membrane(s) and is separated from said carbon dioxide and carbon monoxide.

In order to produce electricity with zero emissions and capture CO₂, the high purity hydrogen which permeates the membrane may be directed to the anode of a high pressure molten carbonate fuel cell and the by-products from the reforming reaction are directed to the cathode of said fuel cell. The high purity hydrogen can also be directed to other types of fuel cells, such as PEM (proton exchange membrane) fuel cells or SOFC (solid oxide fuel cells) and the like.

The invention also pertains to an apparatus comprising a membrane steam reformer heated by flameless distributed combustion to produce hydrogen that may be used for a variety of purposes including as fuel to a fuel cell such as high pressure molten carbonate fuel cell or a PEM fuel cell. The integrated flameless distributed combustion-membrane steam reforming reactor of the present invention comprises:
A reforming chamber comprising a generally tubular reactor having two concentric sections comprising a larger outside section and a smaller inside section and an annulus between said sections, wherein said outside section has an inlet for preheated air and a corresponding inlet for fuel gas, with a flow path between and a plurality (two or more) of flameless distributed combustors arranged in a circular path in said outside section; and wherein said inside section has an inlet for sweep gas and an outlet on said opposite end for sweep gas and H₂, and said annulus has an inlet for vaporizable hydrocarbons and an outlet for by-product compounds and a perm-selective (hydrogen selective), hydrogen-permeable membrane positioned either on the inside or outside of the annular section.

The present invention also pertains to a flameless distributed combustion (FDC) heated, membrane, steam reforming reactor comprising:

a) a reforming chamber containing a reforming catalyst bed, the reforming chamber having an inlet for vaporizable hydrocarbon and steam, a flow path for hydrogen and by-product gases resulting from the reforming reactions taking place in the reforming chamber and an outlet for the by-product gases,

b) at least one flameless distributed combustion (FDC) chamber in a heat transferring relationship with the reforming catalyst bed whereby a distributed, controlled heat flux is provided by the FDC chamber to the reforming catalyst bed, said FDC chamber comprising an inlet and a flow path for an oxidant, an outlet for combustion gas and further comprising a fuel conduit having an inlet for fuel and a plurality of fuel nozzles which provide fluid communication from within the fuel conduit to the flow path of the oxidant, the plurality of fuel nozzles being sized and spaced along the length of the fuel conduit so that no flame results when the fuel is mixed with the oxidant in the FDC chamber;

c) a preheater for preheating the oxidant and/or fuel to a temperature that when the fuel and oxidant are mixed in the FDC chamber, the temperature of the resulting mixture of oxidant and fuel will exceed the autoignition temperature of said mixture; and

d) at least one hydrogen-selective, hydrogen-permeable, membrane tube in contact with the reforming catalyst bed, the membrane tube having an outlet whereby hydrogen formed in the reforming chamber permeates into said membrane tube and passes

through said outlet.

The present invention also relates to a flameless distributed combustion heated, membrane, dehydrogenation reactor comprising:

a) a dehydrogenation chamber containing a catalyst bed, said dehydrogenation chamber having an inlet for vaporizable hydrocarbon, a flow path for hydrogen and product gases resulting from the dehydrogenation reactions taking place in said dehydrogenation chamber and an outlet for said product gases,

b) at least one flameless distributed combustion chamber in a heat transferring relationship with said catalyst bed whereby a distributed, controlled heat flux is provided by said flameless distributed combustion chamber to said catalyst bed, said flameless distributed combustion chamber comprising an inlet and a flow path for an oxidant, an outlet for combustion gas and further comprising a fuel conduit having an inlet for fuel and a plurality of fuel nozzles which provide fluid communication from within the fuel conduit to the flow path of said oxidant, said plurality of fuel nozzles being sized and spaced along the length of said fuel conduit so that no flame results when said fuel is mixed with said oxidant in said flameless distributed combustion chamber;

c) a preheater capable of preheating said oxidant to a temperature that when said fuel and said oxidant are mixed in said flameless distributed combustion chamber, the temperature of the resulting mixture of said oxidant and fuel exceeds the autoignition temperature of said mixture; and

d) at least one hydrogen-selective, hydrogen-permeable, membrane tube in contact with said catalyst bed, said membrane tube having an outlet whereby hydrogen formed in the dehydrogenation chamber permeates into said membrane tube and passes through said outlet.

The present invention further relates to process for dehydrogenation of ethylbenzene, which process comprises the steps of feeding ethylbenzene into the reactor as described above to produce styrene and hydrogen. The catalyst bed contains a dehydrogenation catalyst such as an iron oxide-containing catalyst.

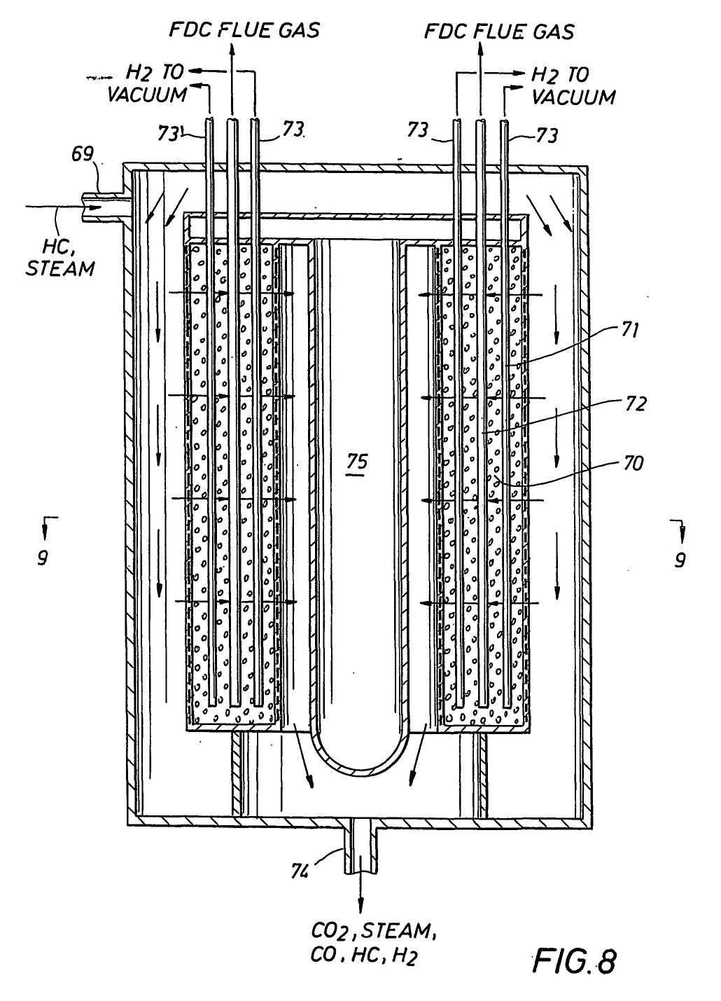

In a preferred embodiment of the invention, the aforesaid FDC heated, membrane, steam reforming reactor contains multiple FDC chambers (preferably, but not necessarily, in the form of tubes) and multiple hydrogen-selective, hydrogen-permeable membrane tubes disposed in, or otherwise in contact with, the reforming catalyst bed in the reforming chamber. Examples of multi-tubular reactors in accordance with the invention are shown in FIGS. 8-9, 11-12, and 14-17.

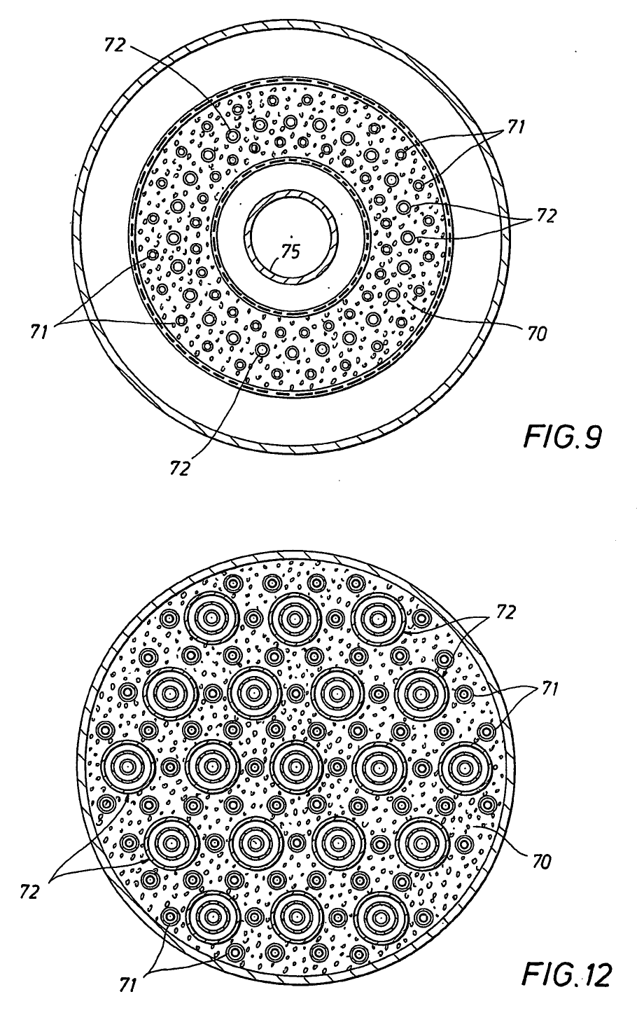

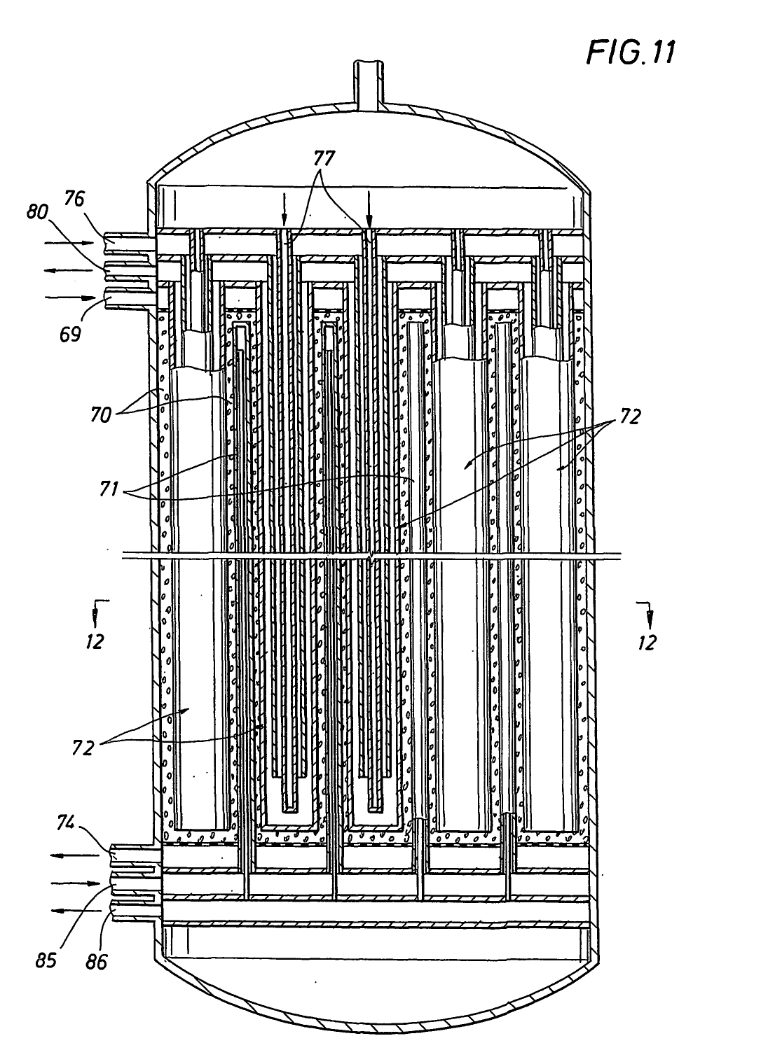

The multi-tubular, FDC heated, membrane, steam reforming reactors in accordance with the invention may be either of the radial flow type as shown in FIGS. 8 and 9, or may be of the axial flow type as shown in FIGS. 11-12 and 14-17. In a radial flow reactor the gases generally flow through the reforming catalyst bed radially from outside to inside (or from inside to outside), while in an axial flow reactor the gases generally flow through the reforming catalyst bed in the same direction as the axis of the reactor. In the case of a vertical reactor, the flow would be from the top of the reactor to the bottom, or the bottom of the reactor to the top.

The multi-tubular, FDC heated, membrane steam reforming reactors in accordance with the present invention may contain from as few as 2 FDC tubes up to 100-or more, particularly 3 to 19, depending the size of the FDC tubes, the size of the catalyst bed and the level of heat flux desired in the catalyst bed. The size of the FDC tube can vary from about 1 inch OD up to about 40 inches or ore OD. The number of hydrogen-selective membrane tubes may also vary from as few as 2 up to 400 or more, particularly 3 to 90. The size of the membrane tubes may vary from about 1 inch up to about 10 inches or more. In general, the ratio of FDC tube surface area to membrane tube surface area will be in the range of about 0.1 to about 20.0, particularly from about 0.2 to about 5.0, more particularly from about 0.5 to about 5.0, still more particularly from about 0.3 to about 3.0 and even more particularly from about 1.0 to about 3.0. The term “surface area” when used in reference to the above ratios, means the external (circumferential) area of the FDC tubes and the membrane tubes. For instance, a 1 inch OD tube of 12 inches length would have an external surface area of 37.6 square inches.

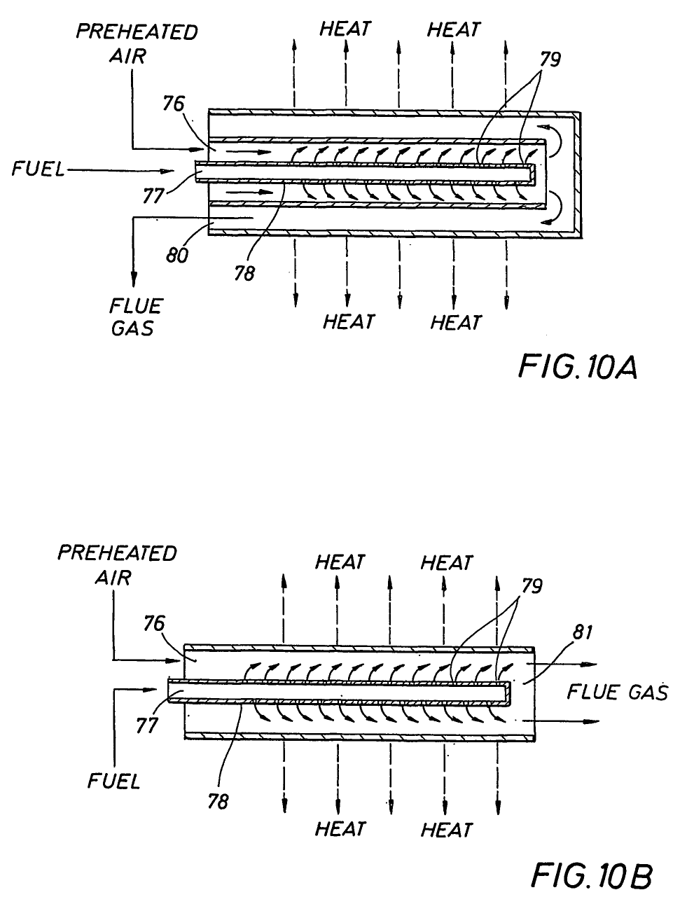

Each FDC tube or chamber will have at least one fuel conduit disposed therein. Larger FDC chambers generally will have multiple fuel conduits. The FDC chambers or tubes employed in the multi-tubular reactors of the invention may be “open ended” or “closed ended” as discussed below in connection with FIGS. 10A and 10B.

A sweep gas may be used to promote the diffusion of hydrogen through the hydrogen-selective, hydrogen-permeable membrane. In case a sweep gas is employed, the membrane tube may contain an inlet and flow path for sweep gas feed and a flow path and outlet for the return of sweep gas and permeated hydrogen.

Baffles and/or screens may also be employed in the multi-tubular reactors of the present invention to improve contact of the reactive gases with the catalyst and to improve flow distribution. The FDC tubes and/or membrane tubes may also be surrounded by cylindrical screens to protect the tubes from direct contact with the catalyst.

In a further embodiment of the invention the reforming chamber of a reactor in accordance with the invention is in communication with a high pressure molten carbonate fuel cell, wherein the outlet for hydrogen from the reformer is in communication with the anode of said fuel cell and the outlet for by-product compounds is in communication with the cathode of said fuel cell.

The integrated FDC-MSR process and apparatus of this invention is capable of producing high purity hydrogen with minimal production of CO, particularly less than about 5 molar %, more particularly less than 3 molar %, and still more particularly less than 2 molar % on a molar dry basis of the total products, and with less than 1000 ppm of CO and particularly less than 10 ppm of CO on a dry basis, more particularly virtually no CO in the hydrogen stream produced. By practice of the present invention it is possible to produce high purity hydrogen e.g., hydrogen having a purity on a dry basis of greater than 95%. The present invention can be used to produce hydrogen having purities as high as 97%, 99%, or under optimum conditions 99+%. The effluent (by product) stream from the MSR reactor will typically contain more than 80% CO₂ on a dry basis, e.g., 90% CO₂, 95% CO₂ or 99% CO₂, and less than about 10% CO on a dry basis, e.g., less than about 5% CO, preferably less than 1% Co.

Total heat management and turbines may be included in the system to increase the efficiency and produce additional electricity or to do useful work such as compress gases or vapors.

One aspect of the present invention is a flameless distributed combustion heated membrane steam reformer hydrogen generator. In the design of the invention there are disclosed distinct improvements in overall efficiency, particularly size, scalability and heat exchange. The present invention typically employs only one reactor to produce the hydrogen versus typically four reactors used in conventional processes, and part of the heat load is supplied by the water-gas-shift reaction. The design of the invention captures essentially all of the heat in the reaction chamber since heat exchange occurs on a molecular level, which reduces the overall energy requirements.

Chemical equilibrium and heat transfer limitations are the two factors that govern the production of hydrogen from methane in conventional reactors. These factors lead to the construction of large reactors fabricated from expensive high temperature tolerant materials. They are enclosed in high temperature furnaces that are needed to supply the high heat fluxes.

In the present invention the two major limitations of chemical equilibrium and heat transfer are overcome by the innovative combination of an in-situ membrane separation of hydrogen in combination with a flameless heat source comprising flameless distributed combustion (FDC) that makes it possible to more efficiently use all the energy in the system, as well as provide load following capabilities.

The reformer of the present invention reduces the operating temperature of the steam reforming reactor close to the lower temperature used in a shift reactor. With the temperatures for the steam reforming and shift closer, both operations are combined into one reactor. With both reactions occurring in the same reactor the exothermic heat of reaction of the shift reaction is completely captured to drive the endothermic steam reforming reaction. This reduces the total energy input for the sum of the reactions by 20%. The lower temperature reduces stress and corrosion and allows the reactor to be constructed from much less expensive materials. Combining the operations also reduces the capital and operating cost since only one reactor, instead of two or three, are required. Moreover, the reaction is not kinetics-limited even at the lower temperature, thus, the same or even less catalyst can be used.

The general description for steam reformers, including but not limited to the reactions, enthalpies, values of equilibrium constants, advantages of integrated FDC-SMR reactor, as well as the advantages of the use of the membrane in the reactor can be found in US 2003/0068269, the entire descriptions of which are herein incorporated by reference.

The in-situ membrane separation of hydrogen employs a membrane fabricated preferably from an appropriate metal or metal alloy on a porous ceramic or porous metal support, as described below, to drive the equilibrium to high conversions. With constant removal of the hydrogen through the membrane, the reactor can be run at much lower than the commercially practiced temperatures of 700-900+° C. A temperature of 500° C. is sufficient to drive the kinetics to high conversions when the equilibrium is shifted using the hydrogen separation membrane. At this temperature the selectivity to CO₂ is almost 100%, while higher temperatures favor the formation of CO as a major product.

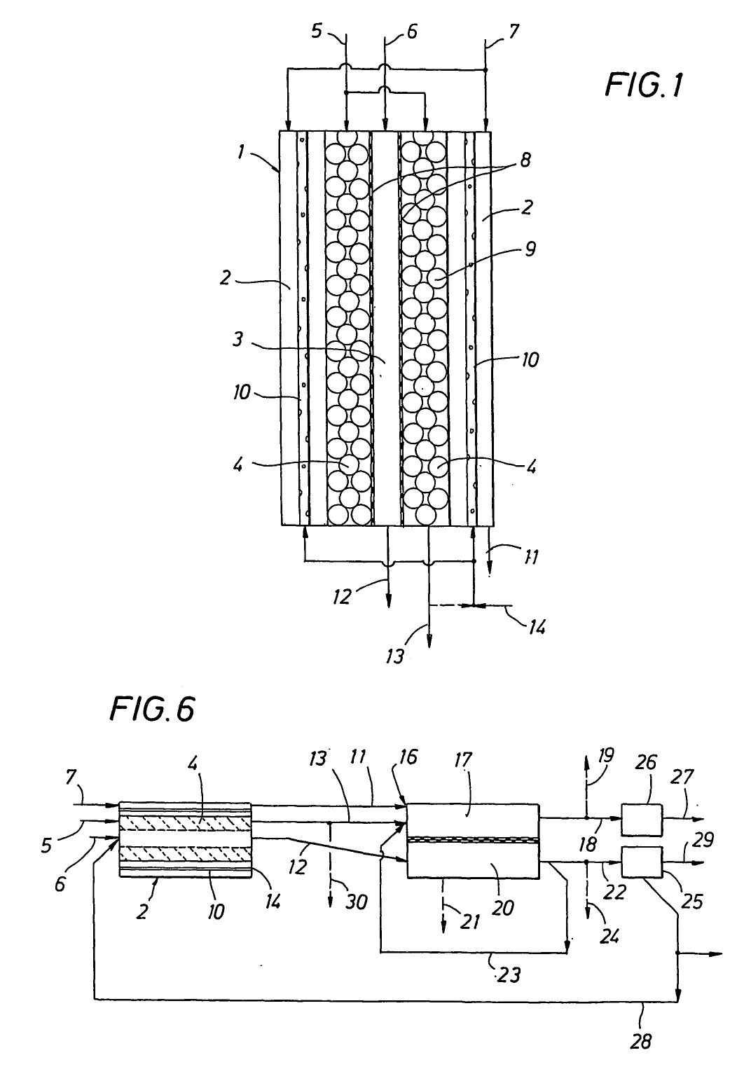

FIG. 1 shows a schematic diagram of a membrane steam-reforming reactor with a flameless distributed combustion (FDC) heater section, catalyst section, and permeate section. The reactor 1 shown in FIG. 1 consists of two concentric sections. The outer concentric section 2 is the FDC heater section, while the inner concentric section 3 is the permeate section. The annulus, 4, in between is the catalyst section. The term “reforming catalyst” as used herein means any catalyst suitable for catalyzing a steam reforming reaction, which includes any steam reforming catalyst known to one skilled in the art, as well as any “pre-reforming catalyst” which is suitable for catalyzing steam reforming reactions in addition to being suitable for processing heavier hydrocarbons prior to a steam reforming reaction. Reforming catalyst is loaded into the annulus section 4 wherein the above-described reactions take place. (section 4 is also variously referred as the catalyst section, the reaction section or the reaction zone). The membrane, 8, is represented on the inside of the small section, 3, (the permeate section) in FIG. 1. The FDC fuel tubes, 10, are placed in a circular pattern in the FDC heating section, while the air flows in that annular region surrounding the fuel tubes. While FIG. 1 shows the FDC heater section, catalyst section and permeate section placed in order from outside in, the location of the membrane and FDC heater section can be reversed to achieve higher membrane area.

The feed gas stream containing a mixture of vaporizable hydrocarbon (e.g. naphtha, methane or methanol) and H₂O with a minimum overall O: C ratio of 2:1 enters catalyst section 4 at 5. If used, sweep gas for promoting the diffusion of hydrogen through the membrane enters the top of the permeate section 3 at 6. Alternatively, sweep gas can be introduced into the permeate section by means of a stinger pipe fitted to bottom of the permeate section. In case of this alternative, hydrogen in sweep gas would exit the permeate zone at the bottom of the permeate section at. 12. Optionally, the stinger pipe to introduce the sweep gas may be connected at the top of the permeate section in which case the hydrogen and sweep gas would exit at the top of this section. Preheated air enters the FDC heater section at 7. Hydrogen (pure or in sweep gas) exits at 12. Flue gas from the FDC heater section exits at 11. Unreacted products and by-products (e.g., CO₂, H₂O, H₂, CH₄, and CO) exit catalyst section 4 at 13. Fuel 14 (which may include a portion of the hydrogen exiting the permeate section or part of the reactor effluent) enters the FDC fuel tubes 10 as shown and is mixed with the preheated air in the FDC heating section. It is also possible to remove the produced hydrogen using a vacuum instead of a sweep gas.

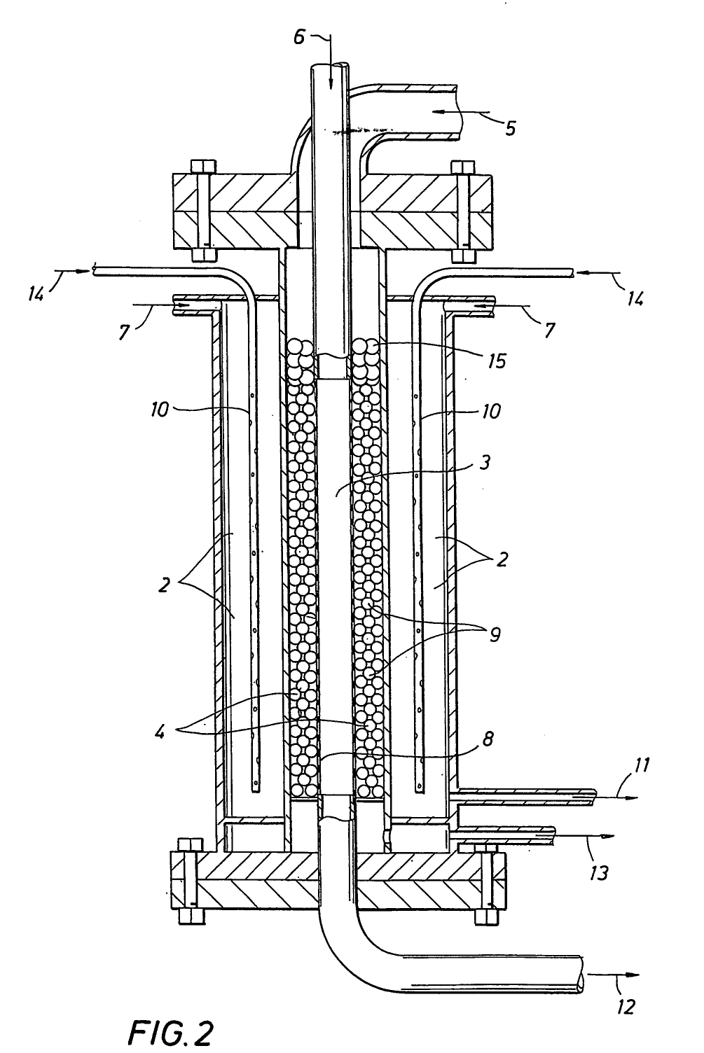

FIG. 2 shows a schematic diagram of another embodiment of the integrated FDC-MSR reactor of the present invention. The reactor depicted in FIG. 2, similar to the reactor in FIG. 1, has an outer concentric FDC heater section 2 and an inner permeate section 3, with an intermediate catalyst section 4 containing catalyst 9. The catalyst section also contains a layer of inerts 15 at the top of the catalyst section. A feed stream containing a vaporizable hydrocarbon (e.g. naphtha, methane or methanol) and steam enter the reactor at 5, while sweep gas, if used, enters the reactor at 6. Fuel for the FDC heater section enters fuel tubes 10 at 14. However, in the case of this embodiment the fuel enters the FDC heating section at the top of the section and flows concurrently with the preheated air (or other oxidant) which enters the FDC heating section at 7. The flow in the FDC heating section is also co-current with the flow of the reactant gases in section 4. Fuel tubes 10 have a plurality of openings or nozzles sized and spaced along the length of the fuel tubes so that the amount of fuel mixing with the air or oxidant in the annular part of the FDC section surrounding the fuel tubes can be controlled to achieve the desired heat distribution along the length of the FDC heating section which in this embodiment surrounds the reaction section. Flue gas containing very low levels of NOₓ leaves the FDC heater section at 11, while effluent from the catalyst (reaction) section exits at 13. Hydrogen formed in reaction section permeates through hydrogen-selective, hydrogen-permeable, membrane 8 and exits the permeate section (as such or with sweep gas) at 12.

The novel integrated FDC-membrane steam-reforming reactor of the present invention operates at a lower temperature than that used in conventional steam methane reformers. A suitable temperature is less than about 700° C., for example in the range of from about 300 to about 650° C. In some cases lower temperatures, e.g., as low as about 200° C. can be used up to about 600° C. A preferred range is from about 400 to about 550° C., more preferably from about 400° C. to about 500° C. Suitable pressure is in the range of from about 1 to about 200 bar, preferably from about 10 to about 50 bar. The simulation in Example 1 of the present invention was carried out at a temperature of about 500° C. and 30 Bar. This low temperature achieves high selectivity to CO₂ and negligible selectivity to CO.

Any vaporizable (or optionally oxygenated) hydrocarbon can be used in the present process and apparatus, including, but not limited to, methane, methanol, ethane, ethanol, propane, butane, light hydrocarbons having 1-4 carbon atoms in each molecule, and light petroleum fractions like naphtha at boiling point range of 120-400° F., which is a typical feed for commercial steam reformers. Petroleum fractions heavier than naphtha can also be employed like diesel or kerosene or jet fuel at boiling point range of 350-500° F. or gas oil at boiling point range of 450-800° F. Hydrogen, carbon monoxide and mixtures thereof, e.g., syngas, may also be used in the process and apparatus of the present invention, and are included in the definition of “vaporizable hydrocarbon”. Methane was used in the examples to demonstrate the process.

With the FDC-MSR process and apparatus of the present invention it is possible to use O: C ratios as low as 2.8, down to 2.6, without coking problems, with the minimum O: C ratio being about 2:1. This results lower energy costs if methane is used as the feed in the present invention, since lower steam to methane ratios can be used thus requiring less energy to vaporize water. Because of the ability to operate at lower O:C ratios, it is also possible to use heavier, less expensive feeds in the FDC-MSR reactor of the present invention than can be used in conventional steam methane reformers.

In another embodiment of the invention, the integrated FDC-MSR process and apparatus of the invention can be used to perform water-gas-shift reactions on syngas mixtures (i.e., mixtures of hydrogen and carbon monoxide) produced from conventional processes like Catalytic Partial Oxidation (CPO), Steam Methane Reforming (SMR) and Autothermal Reforming (ATR). The integrated FDC-MSR reactor is well suited for this since it produces high purity hydrogen and converts carbon monoxide to carbon dioxide and more hydrogen. Thus, the versatile FDC-MSR reactor of the invention is capable of replacing the high temperature shift, low temperature shift and methanation reactors and the hydrogen purification section. A mixture of syngas and vaporizable hydrocarbon can also be used to yield a net reaction which may be either endothermic, thermally neutral or slightly exothermic.

The reactor annulus is packed with steam reforming catalyst and equipped with a perm-selective (i.e., hydrogen selective) membrane that separates hydrogen from the remaining gases as they pass through the catalyst bed. The steam reforming catalyst can be any known in the art. Typically steam reforming catalysts which can be used include, but are not limited to, Group VIII transition metals, particularly nickel. It is often desirable to support the reforming catalysts on a refractory substrate (or support). The support is preferably an inert compound. Suitable compounds contain elements of Group III and IV of the Periodic Table, such as, for example the oxides or carbides of Al, Si, Ti, Mg, Ce and Zr. The preferred support composition for the reforming catalyst is alumina.

The catalyst used in the examples to demonstrate the present invention was nickel on porous alumina. As the hydrogen is formed in the catalyst bed, it is transported out through the hydrogen-permeable separation membrane filter. Advantages of this technology include the capacity to separate essentially pure hydrogen from any poisons that may also be present, including CO and H₂S, and from other fuel diluents. The poisons do not pass through the separation membrane, which is fabricated from one of a variety of hydrogen-permeable and hydrogen-selective materials including ceramics, carbon, and metals.

Membranes which are suitable for use in the apparatus and process of the present invention include, but are not limited to, (i) various metals, such as hydrogen permeable transition metals selected from Group IIIB, IVB, VB, VIIB and VIIIB of the periodic table and metal alloys or metal hydrides of such metals, (ii) molecular sieves, ceramics, zeolites, silica, alumina, refractory metal oxides, carbon, (iii) organic polymers, and mixtures thereof. Illustrative, but non-limiting, examples of hydrogen separating devices utilizing such membranes include the membranes described in U.S. Pat. No. 5,217,506, issued Jun. 8, 1993 to David J. Edlund et al, U.S. Pat. No. 5,259,870, issued Nov. 9, 1993 to David J. Edlund et al and U.S. Pat. No. 5,451,386, issued Sep. 19, 1995 to Collins et al, and U.S. Pat. No. 6,152,987, issued Nov. 28, 2000, the descriptions of all of which are incorporated herein by reference.

Membranes, which are especially suitable for use in the present invention, include various metals and metal alloys on porous ceramic or porous metal supports. The porous ceramic or porous metallic support protects the membrane surface from contaminants and, in the former choice, from temperature excursions. Illustrative, but non-limiting examples of materials suitable for use as a support for the membranes which may be used in the apparatus and process of the present invention include an inorganic porous material such as palladium, platinum, palladium alloys, porous stainless steel, porous silver, porous copper, porous nickel, porous Ni-based alloys, metal mesh, sintered metal powder, refractory metals, metal oxides, ceramics, porous refractory solids, honeycomb alumina, aluminate, silica, porous plates, zirconia, cordierite, mullite, magnesia, silica matrix, silica alumina, porous Vycar, carbon, glasses, and the like.

A particularly suitable membrane support is porous stainless steel or porous Ni-based alloy. Porous nickel-based alloys, like Hastelloy and Inconel, are particularly suitable as being stable at high temperatures. Ni-based alloys have also high mechanical strength and this strength is maintained at high temperatures. Ni-based alloys also have high resistance to oxidation and scaling when exposed to steam, a feed that is present in steam reforming reactions. Ni-based alloys also have high resistance to chloride pitting. This assures that the support will not pit if there is trace of chloride left over from the plating solution after the rinsing and drying steps usually employed. Particularly, Alloy 625 (or Inconel 625) is superior in resistance to crevice corrosion, uniform corrosion and stress corrosion cracking. It has a niobium addition that stabilizes the alloy against sensitization during welding, thereby preventing subsequent inter-granular attack. Alloy 625 is resistant to hydrochloric acid, nitric acid, neutral salts and alkali media. Alloy 625 resists cracking in both oxidizing and non-oxidizing environments. It has very high allowable design strength and is able to withstand temperatures up to 760° C. Alloy 625 has a high amount of Chromia (ceramic) on the surface, which can act as a barrier to the inter-metallic diffusion of Palladium with Fe (iron) or other metals. The Pd layer can be deposited on the outside of the porous ceramic or metallic support, in contact with the catalyst section, or it can be deposited on the inside thereof. The inertness, range of porosity available, and the fact that, to some extent, alumina can function as an insulator, also make it a good choice for the support. Additional advantages include the fact the alumina can function to filter off material that might deposit on the membrane and plug it. The use of alumina also makes it possible to control the distance of the membrane from the catalyst section, and, therefore, control the temperature drop across the operating membrane at a given temperature and maximum effectiveness, and lessens the likelihood of overheating. It is also possible to use the ceramic support as an insulating layer to keep the membrane at the design temperature. The temperature of the sweep gas may also be controlled to adjust the membrane temperature. The membrane permeate side can provide extra heat transfer area, with superheated steam used as sweep gas and also as a heat transfer fluid for heating and temperature control. Also, a combustion catalyst with some oxygen injection via a perforated tube can oxidize some of the produced hydrogen to supply the enthalpy to drive the steam reforming reaction. The presence of Pd or Pd-alloy in the vicinity of the air and hydrogen mixture makes this reaction occur at lower temperature than the autoignition temperature of hydrogen and air (which is 571° C.). This results in a heat source that does not exceed the maximum operating temperature of the preferred Pd membrane, which is around 550° C. This internal heating concept is based on flameless distributed combustion concepts and is an example of inverse combustion and may be used with or with out catalyst surrounding the perforated tube that supplies the oxygen. Optionally, a suitable methanation catalyst may be placed in the permeate compartment as an extra safeguard to CO penetration through the hydrogen membrane if small pinholes develop. This catalyst could convert CO to methane and keep the CO level in the hydrogen stream always in the parts per million range. Typically, the CO level in the hydrogen stream exiting the membrane steam reforming reactor of the present invention will be less than about 10 ppm, e.g., less than 5 ppm, 2 ppm, 1 ppm or 0.1 ppm.

Preferred materials for fabricating said membrane include mainly, but not exclusively, metals of Group VIII, including, but not limited to Pd, Pt, Ni, Ag, Cu, Ta, V, Y, Nb, Ce, In, Ho, La, Au, etc. particularly in the form of alloys. Pd and Pd alloys are preferred. The membrane used to demonstrate the present invention was a very thin film of a palladium alloy having a high surface area. Membranes of this type can be prepared using the methods disclosed in U.S. Pat. No. 6,152,987, which is incorporated by reference herein in its entirety. Platinum or a platinum alloy would also be suitable.

As mentioned, with respect to FIG. 1, the membrane is pictured on the inside of the smaller (i.e., the inner) concentric section, which reduces the surface area to a minimum. In order to obtain greater flux, the membrane could be placed on the outside of the larger section of the reactor. Changes in geometry of the membrane permit a number of options depending on requirements as will be apparent to those skilled in the art. For example, one option is to place the membrane on the outside of the reactor wall to achieve higher surface area. If in Example 1 the membrane was placed on the outside tube of the 14 cm diameter, the surface area value can be increased by a factor of 2. Also, more tubes of smaller diameter can be used to achieve a higher surface to volume ratio. A jagged cross-section of the membrane tube (with star shape for instance) could increase the surface area. Finally, the space velocity of the gas may be reduced, e.g. by 2-3 or 2200-3300 h⁻¹, to allow more time for the hydrogen to diffuse through the membrane.

The hydrogen separation membrane used in Example 1 was a Palladium-alloy (such as alloy of palladium with one or more other metals such as Ag, Cu, Au, Ta, V, etc.) thin film of 1 μm or less with a high surface area. The Pd-alloy film is supported on a porous ceramic matrix that acts as the mechanical support and a filtration medium to prevent coke from covering the membrane. The porous ceramic support also acts as an insulator to reduce heat losses from the reactor. It also keeps the membrane at the specified temperature for optimum performance and stability. This special design geometry is highly efficient. The permeability used for the base case is 7.8 10⁻² std-m³/m²/s/Bar^{0.5} which is a number 2-30 times higher than reported in the literature which can be found in Table 2 of US2003/0068269, the description thereof and the commercially available membranes described therein are herein incorporated Steam is not known to cause a problem in membrane stability, however, if any problems developed at higher temperatures, the replacement of water with recycled carbon dioxide or nitrogen as sweep gas is a viable alternative. Other sweep gases could be used, like hydrocarbons, or mixtures thereof, with a moderate boiling point of 100-400° C. These would condense at temperatures closer to the permeate outlet temperature and thus reduce the energy loss during cooling and reheating of the sweep gas. Hydrocarbons have lower condensation enthalpy than water, thus, they may reduce the heat exchanger size requirements. They can also reduce the sweep gas impurities in the purified H₂ stream since they have low vapor pressure at the condensation temperature. A mixture of hydrocarbons can make the condensation occur in a range of temperatures, and thus, avoid the pinch point limitation occurring with a single and sharp boiling point.

As a particular embodiment of the present invention, the permeate section can be connected to a metal hydride precursor compartment which reacts with the permeating hydrogen to form metal hydride. This reaction reduces the effective partial pressure of hydrogen in the permeate stream and increases the driving force for hydrogen flux.

In the present invention heat transfer limitations are overcome by the innovative use of flameless distributed combustion (FDC) as the primary heat source. FDC is used to distribute heat throughout the reactor at high heat fluxes without high temperature flames and with low NOₓ production. This is achieved by injecting small quantities of fuel into a preheated air stream and reaching autoignition conditions. Fuel quantity is controlled by nozzle size, the temperature rise is very small, and there is no flame associated with the combustion (combustion is kinetically limited, rather than mass-transfer limited). The reaction in the case where methane is used as fuel for FDC is:

Combustion: CH₄+2O₂ [symbol] CO₂+2H₂O −802.7 kJ/gmol

Comparing the enthalpies of this reaction with the reforming of methane to CO₂, it is obvious that the minimum amount of methane that needs to be combusted in order to support reforming is 17% of the total methane used (ratio of 1:4.9 to the reformed methane).

Flameless distributed combustion is disclosed in U.S. Pat. No. 5,255,742, U.S. Pat. No. 5,862,858, U.S. Pat. No. 5,899,269, U.S. Pat. No. 6,019,172, and EP 1 021 682 B1 the disclosures of which are hereby incorporated by reference herein in their entirety.

An important feature of the flameless distributed combustion is that heat is removed along the length of the combustion chamber so that a temperature is maintained that is significantly below what an adiabatic combustion temperature would be. This almost eliminates formation of NOₓ, and also significantly reduces metallurgical requirements, thus permitting the use of less expensive materials in construction of equipment.

Generally, flameless combustion is accomplished by preheating combustion air and fuel gas (e.g., methane, methanol, hydrogen and the like) sufficiently such that when the two streams are combined the temperature of the mixture exceeds the autoignition temperature of the mixture, but to a temperature less than that which would result in the oxidation upon mixing, being limited by the rate of mixing. Preheating of the combustion air and fuel streams to a temperature between about 1500° F. and about 2300° F. and then mixing the streams in relatively small increments will result in flameless combustion. For some fuels such as methanol, preheating to a temperature above about 1000° F. is sufficient. The increments in which the fuel gas is mixed with the combustion gas stream preferably result in about a 20° to about 200° F. temperature rise in the combustion gas stream due to the combustion of the fuel.

With most steam methane reforming processes controlling the temperature in the catalyst bed is a problem. The advantages of the flameless distributed combustion as a heat source in the present process and apparatus can be summarized as follows:
FDC helps maintain a more uniform temperature, but simultaneously controls heat-flux to match the local heat needed for the material left to be reacted. At the highest heat flux there is as much heat present as can be accommodated by the reaction and as the process progresses less and less heat is required to drive the reaction.
FDC has a lower maximum-temperature combustion gas.
FDC does not have hot spots which might damage the hydrogen-selective, hydrogen-permeable membrane.
FDC has a negligible NOₓ production.
FDC makes it easier to tailor axial heat flux distribution to minimize entropy production or energy loss and, thus, making it more efficient.
FDC permits a more compact reactor design that is less expensive to build.
FDC permits a modular reactor design, at a wide range of sizes and heat duties.

FDC provides a tapered heat flux profile.

Thus, the flameless distributed combustion (FDC) used to drive the steam reforming reactions in the present invention can be described as comprising:
e) preheating either a fuel gas or oxidant or both to a temperature that exceeds the autoignition temperature of the mixture of the fuel gas and oxidant when they are mixed;
f) passing said fuel gas and oxidant in into a heating zone which is in heat transferring contact along a substantial portion of the reaction zone (i.e., the zone in which said reforming reactions take place); and
g) mixing the fuel gas and oxidant in said heating zone in a manner that autoignition occurs, resulting in combustion without high temperature flames, thereby providing uniform, controllable heat to said reaction zone.

In the practice of the invention, some degree of sulfur removal will probably be necessary to protect the palladium material making up the hydrogen-permeable separation membrane and the Ni reforming catalyst. Sulfur is a temporary poison to such catalysts, but the catalyst activity can be regenerated by removing the source of sulfur. The sulfur tolerance of commercial reforming catalysts is dependent upon process conditions. On average, sulfur must be reduced to below 10 ppb to allow the catalyst to function properly.

Feed clean up with ZnO beds or by other means known in the art may be used to remove impurities such as H₂S and other sulfur containing compounds in the feed that could contribute to membrane degradation. For heavier hydrocarbons, like naphtha, some hydrotreating may be necessary to convert organic sulfur to H₂S, as known in the art. Heavy oil, solids carried by liquid water, oxygen, amines, halides, and ammonia are also known poisons for palladium membranes. Carbon monoxide competes with hydrogen for active surface sites, thus reducing the hydrogen permeability by 10% at 3-5 Bar. Thus, the partial pressure needs to stay low for best performance, as is the case in our preferred design.

In another embodiment of the present invention the FDC-MSR generated pure hydrogen is used in an integrated design to power a fuel cell. This embodiment of the present invention has the potential for about 71% or greater efficiency in the generation of electricity from starting fuel. In addition, due to the unique integration of the system, CO₂ is produced in high concentrations from about 80% to about 95% molar dry basis, and high pressure of from about 0.1 to about 20 MPa, particularly from about 1 to about 5 MPa (S.I.), and is easier to separate from nitrogen, which makes the system even more efficient.

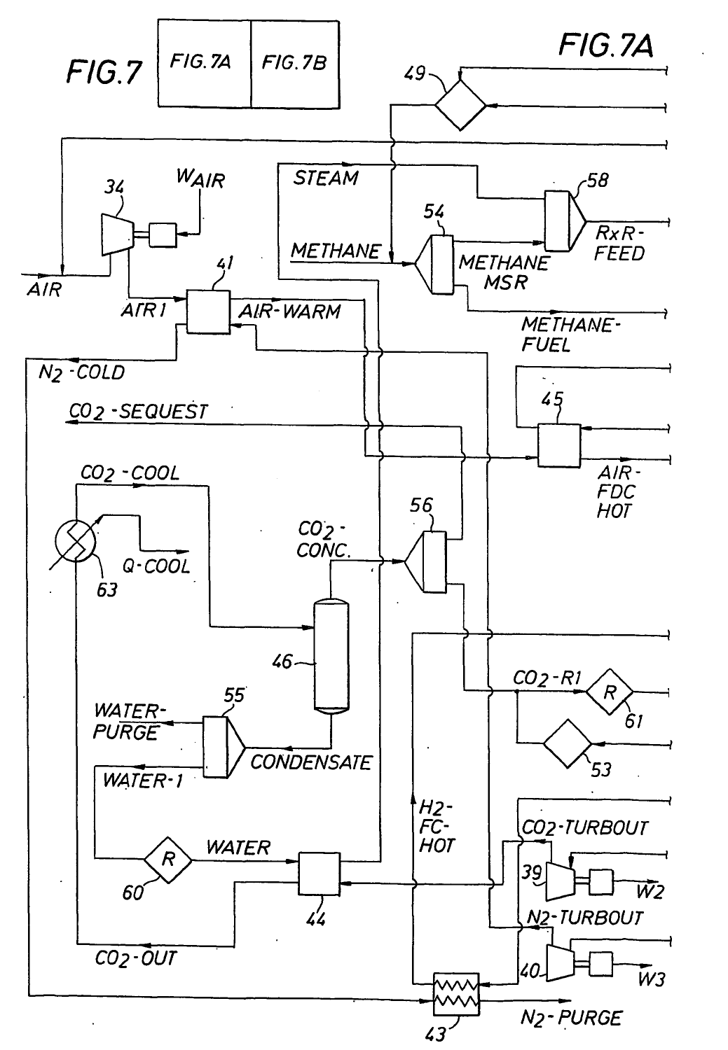

Referring now to FIG. 6, a vaporizable hydrocarbon and steam 5 are fed into the catalyst section 4 of a FDC-membrane reactor of the type described in FIG. 1, while preheated air 7 and fuel 14 are fed into the FDC heating section 2 of the reactor containing fuel tubes 10. A sweep gas (in this case steam) is fed into the FDC-membrane reactor at 6. The produced high purity hydrogen stream, 12, is directed to the anode compartment of the molten carbonate fuel cell, 20, operating at about 650° C. and 5 Bar. The reactor effluent 13 containing the unreacted steam, CO₂ and low quantities of methane, hydrogen and CO, and the flue gas 11 from the FDC heater and air, 16 are fed to the cathode compartment of the same fuel cell, 17. The CO₂ reacts with the O₂ to form CO₃⁼ anions that transport through the molten carbonate membrane. The CO₃⁼ anions are constantly renewed. The reactions with indicated transport are described as follows:
CO_{2 cathode}+½O_{2 cathode}+2e⁻_{cathode}→CO_{3 cathode}⁼ R. 1
CO_{3 cathode}⁼→CO_{3 anode}⁼ R. 2
CO_{3 anode}⁼→CO₂+½O_{2 anode}+2e⁻_{anode} R. 3
H_{2 anode}+½O_{2 anode}→H₂O_{anode}−242 kJ/gmol-H₂ R. 4
Net: H_{2 anode}+½O_{2 cathode}+CO_{2 cathode+}2e⁻_{cathode}→H₂O_{anode}+CO_{2 anode}+2e⁻_{anode}−242 kJ/gmol-H₂ R. 5

Electricity generated by the fuel cell is shown as electrical output 21. The stream from the anode, 22, now contains the permeated CO₂ and steam but no hydrogen, nitrogen, methane or oxygen, if hydrogen and oxygen are fed in exactly 2:1 stoichiometry. A portion of stream 22 may recycled to the cathode compartment 17 of the fuel cell. The CO₂ recycle stream is shown as 23 on FIG. 6. A portion of streams 22 and/or 13 also may be put through a turbine expander to generate electrical or mechanical work 30 and 24, respectively. In the present invention CO₂ is separated from nitrogen essentially for free while electricity is simultaneously generated. Furthermore the CO₂ capture leverage is high. As shown above, each mole of methane is converted to 4 moles of H₂. Therefore 4 moles of CO₂ per mole of converted methane are required to transport the oxygen in the fuel cell and are therefore separated from the nitrogen. Thus, this process can also be used to separate CO₂ from an external CO₂ containing stream. The high concentration CO₂ stream, 29, is now a prime candidate for sequestration after the steam is condensed. The CO₂ can be used for oil recovery, or injected into subterranean formations, or converted to a thermodynamically stable solid. Also, since the present process can be operated to produce high purity hydrogen and nitrogen as well as concentrated CO₂, it can be used to facilitate the production of chemicals such as urea, which can be made from these three raw materials. Other chemicals which can be manufactured using the products and by-products of the present process include ammomia and ammonium sulfate. Other uses for the concentrated stream of CO₂ and the high purity hydrogen and nitrogen streams will be apparent to those skilled in the art.

The stream from the cathode, stream 18, contains all the nitrogen, unreacted oxygen, a little unpermeated CO₂, and trace amounts of the methane, hydrogen and CO from the MSR effluent. All or part of this stream can be put through a turbine expander (not shown) to generate work (electrical or mechanical), 19. The trace components of stream 18 may be oxidized in a catalytic converter, 26, and emitted in the atmosphere as a low CO₂ concentration containing stream, 27, containing less than 10% CO₂, preferably less than 1% CO₂. The trace components may also be oxidized inside the fuel cell if the appropriate catalyst is placed in the cathode compartment. A stream, 28, containing water and steam exits condenser 25 and is recycled to the FDC-MSR reactor, and reheated to between about 250 to 500° C.

The zero emission hybrid system of the present invention is extremely efficient. Byproduct compounds are separated, the steam and hydrogen are reheated efficiently, and electricity is produced. Furthermore, water is separated from purified CO₂ which is produced in concentrations large enough to be easily sequestered. Advantages include using waste heat to raise steam and using water collected for recycling to support additional steam reforming or other beneficial uses. The system is a totally integrated, extremely efficient design having the potential for greater than 71% generation efficiency as mentioned above. The 71% is approximately a 20% fractional improvement over the best results we are aware of in the art, the 60% figure mentioned above that is possible under laboratory conditions. In addition to the great improvement in efficiency, the integrated design provides a concentrated source of CO₂ for capture and sequestration as well.

Fuel cells which would be suitable for use in the present invention are those that could function in a highly pressurized system. Most fuel cells run at atmospheric conditions. For this reason, a high pressure molten carbonate fuel cell is preferred. However, other types of fuel cells, such as PEM fuel cells and SOFC, can also be effectively combined with the FDC-MSR reactor of the present invention.

Another very attractive feature is that the FDC powered MSR hydrogen generator produces very low NOₓ, especially compared with the combined processes known in the art. Due to the use of flameless distributed combustion very little NOₓ is generated in this system. Furthermore, other steam reforming reactors used to generate hydrogen known in the art could not feed to the MCFC the flue gas from the furnace as in the present design, because they produce high NOₓ, which would poison the molten carbonate membrane.

The following illustrative embodiments will serve to illustrate the invention disclosed herein. The examples are intended only as a means of illustration and should not be construed as limiting the scope of the invention in any way. Those skilled in the art will recognize many variations that may be made without departing from the spirit of the disclosed invention.

### ILLUSTRATIVE EMBODIMENT 1

FIG. 8 shows a schematic diagram of a multi-tubular, FDC heated, radial flow, membrane, steam reforming reactor in accordance with the present invention. In the reactor shown in FIG. 8, a vaporizable hydrocarbon and steam enter the reactor at inlet 69 and flow through the reforming catalyst bed 70 (which is in the form of an annulus) containing multiple membrane tubes 71 and multiple FDC tubes 72 surrounded by the catalyst bed. In this embodiment the feed gases and reaction gases flow through the catalyst bed radially from outside to inside. The multiple hydrogen-selective, hydrogen-permeable, membrane tubes 71 are disposed axially in concentric rows in the reforming catalyst bed and serve to remove hydrogen, which is produced by the reforming reactions. The multiple FDC tubes (i.e., chambers) 72 are also disposed axially in concentric rows in the reforming catalyst bed (for example, in a ratio of 1:2 or other number of FDC tubes to the number of membrane tubes). The multiple FDC tubes are in contact with the reforming catalyst bed and provide a controlled, distributed heat flux to the catalyst bed sufficient to drive the reforming reactions. While the membrane tubes and the FDC tubes are shown to be in concentric rows in FIG. 8, other geometric arrangements of these tubes can be suitably employed, and are within the scope of the present invention.

The FDC tubes 72 generally comprise a fuel conduit disposed within a larger tube with an inlet and flow path for a preheated oxidant (e.g., preheated air) and an outlet for combustion (flue) gas. The FDC tubes may be closed ended with a fuel conduit, oxidant inlet and flow path, and flue gas outlet arranged as shown in FIG. 10A, or may open ended with the fuel conduit, oxidant inlet and flow path arranged as shown in FIG. 10B.

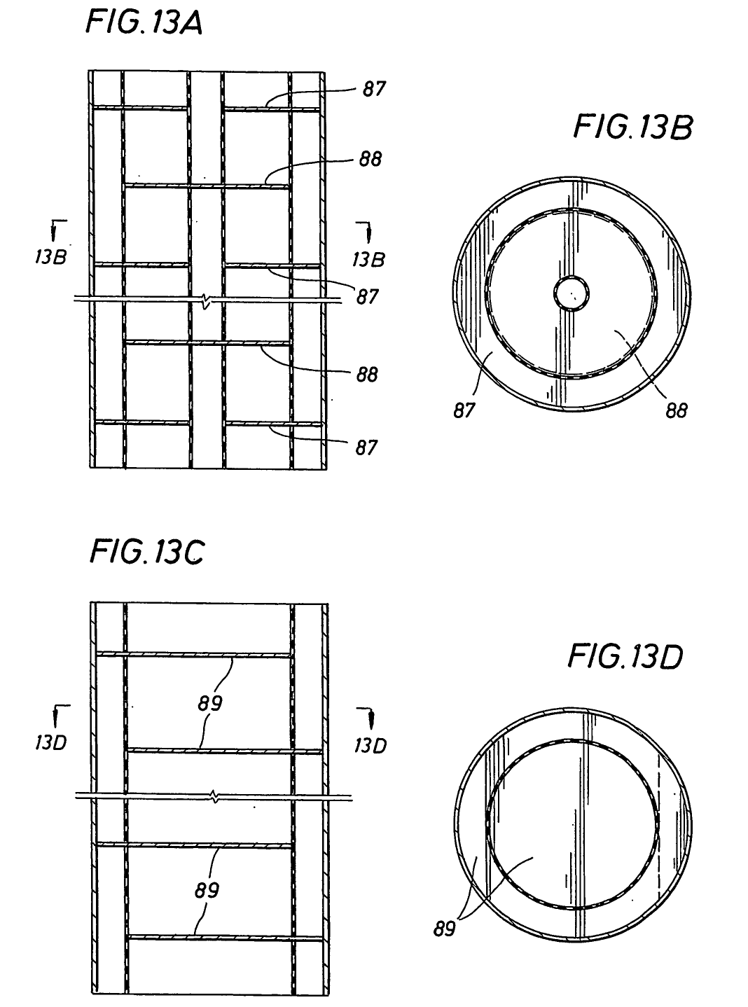

High purity hydrogen is removed from the multi-tubular, radial flow, reactor shown in FIG. 8 via outlets 73, with the aid of vacuum. Optionally, a sweep gas may be used to promote the diffusion of hydrogen through the membrane of the membrane tubes 71. If a sweep gas is employed, the membrane tubes 71 may contain an outer sweep gas feed tube and an inner return tube for sweep gas and hydrogen as discussed in FIG. 12. By-product gases, including uppermeated hydrogen, if not further used internally for heat production, e.g., combustion or heat exchange, exit the multi-tubular, radial flow, reactor via outlet 74. A hollow tube or cylinder 75 may optionally be used for flow distribution.

### ILLUSTRATIVE EMBODIMENT 2

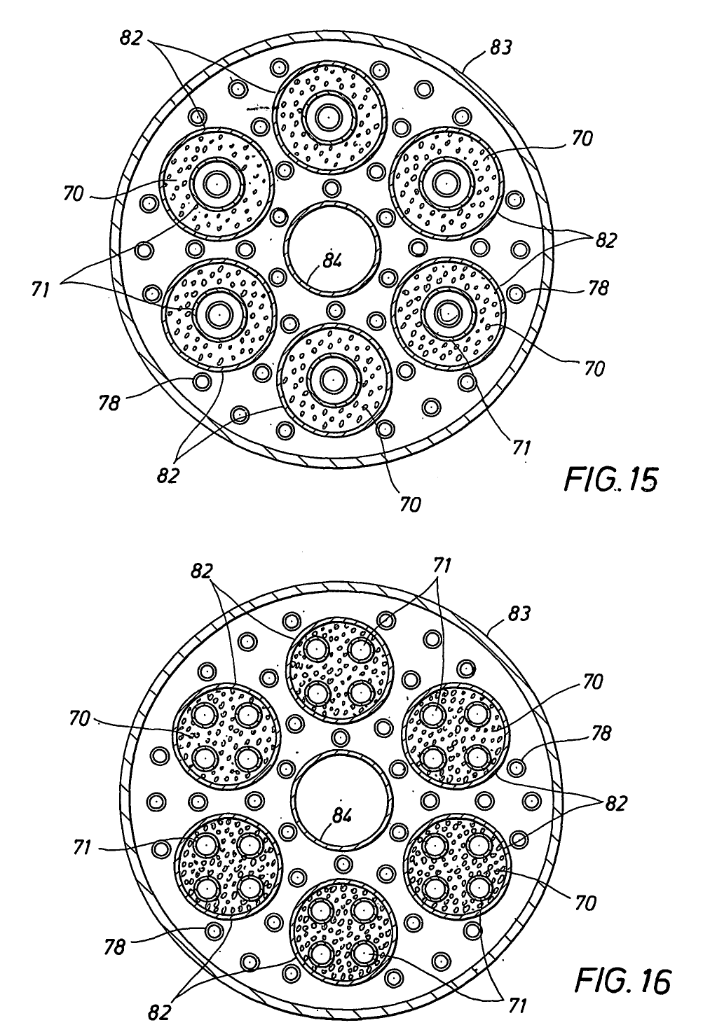

FIG. 9 is a top cross-section view of the shell of the multi-tubular, FDC heated, radial flow, membrane, steam reforming reactor of FIG. 8. The cross sectional view of the reactor shows multiple membrane tubes 71 and multiple FDC tubes 72 dispersed in catalyst bed 70 with optional hollow tube or cylinder 75 being in the center of the reactor. In the example shown, the membrane tubes 71 have outside diameters (OD) of about one inch while FDC tubes have an OD of approximately two inches, although other sizes of these tubes can be suitably employed. If a sweep gas is employed, the membrane tubes 71 may contain an outer sweep gas feed tube and an inner return tube for sweep gas and hydrogen as shown in FIGS. 12 and 14. A larger shell containing more tubes duplicating this pattern can also be used.

### ILLUSTRATIVE EMBODIMENT 3

FIGS. 10A and 10B are schematic diagrams showing an example of a “closed ended” and of an “open ended” FDC tubular chamber which are used to drive the reforming reactions in various embodiments of the present invention. Referring to FIG. 10A, an oxidant (in this case preheated air) enters the FDC tube at inlet 76 and mixes with fuel which enters the FDC tube at inlet 77 and passes into fuel conduit 78 through nozzles 79 spaced along the length of the fuel conduit, whereupon it mixes with the air which has been preheated to a temperature such that the temperature of the resulting mixture of fuel and air is above the autoignition temperature of the mixture. The reaction of the fuel passing through the nozzles and mixing with the flowing preheated air at a temperature above the autoignition temperature of the mixture, results in flameless distributed combustion which releases controlled heat along the length of the FDC tube as shown, with no flames or hot spots. The combustion gases, (i.e., flue gas) exit the FDC tube at outlet 80.

In the “open ended” FDC tubular chamber shown in FIG. 10B, preheated air enters the FDC tube at inlet 76 and the fuel at inlet 77, and the fuel passes through conduit 78 and nozzles 79, similar to “closed end” FDC tube in FIG. 10A. However, in the case of the “open ended” FDC tube, the flue gas exits the FDC tube at open end 81, instead of outlet 80 as shown in FIG. 10A.

### ILLUSTRATIVE EMBODIMENT 4

FIG. 11 is a schematic drawing of a multi-tubular, FDC heated, axial flow, membrane, steam reforming reactor in accordance with the present invention. In the reactor shown in FIG. 11, a vaporizable hydrocarbon and steam enter the reactor at inlet 69 and flow through the reforming catalyst bed 70 containing multiple hydrogen-selective membrane tubes 71 and multiple FDC tubes 72. In this embodiment the feed gases and reaction gases flow through the catalyst bed axially from the top of the catalyst bed to the bottom. The multiple hydrogen-selective membrane tubes 71 are disposed axially in the reforming catalyst bed and serve to remove hydrogen which is produced by the reforming reactions. In the embodiment shown the membrane tubes are closed at the top and a sweep gas (e.g. steam) is employed, which enters the reactor at inlet 85 into the bottom of the membrane tubes where it flows upward in the outer part of the membrane tube, counter-current to the hydrocarbon and steam feed. A stinger pipe fitted to the bottom of the permeate section may be used to distribute the sweep gas in the membrane tube. The permeated hydrogen and sweep gas flow downward in a return tube located in the center of the membrane tube and exit the reactor via outlet 86. The pressure drop in the permeate pipe section is significant when the length of the pipe relative to the diameter exceeds a given limit. Actually, the volumetric amount of hydrogen crossing the membrane is proportional to the membrane area, □*D*L and the multiplier is the velocity, which is fixed as a function relating to Sievert's law, the description of which can be found in US2003/0068269 and is herein incorporated by reference. The same hydrogen amount has to flow across the pipe cross section which is equal to □*D²/4. The ratio of hydrogen velocities through the pipe and through the membrane respectively is proportional to (□*D*L)/ . . . □*D²/4) or to L/D. Pressure drop increases with gas velocity. If this ratio exceeds a limit, then the velocity in the permeate pipe exceeds a limit too, since the velocity through the membrane is fixed. Then the pressure drop in the permeate pipe becomes high and it reduces the hydrogen flux by creating back pressure in the permeate section. In such a case, the reactor design has to accommodate either a higher membrane diameter, or a reduced length.

There are also multiple FDC tubes (i.e., chambers) 72 disposed axially in the reforming catalyst bed. In the embodiment shown the FDC tubes are “closed ended” tubes with preheated air entering at inlet 76, fuel entering at 77 and combustion gas (i.e., flue gas) exiting the reactor at outlet 80. The multiple FDC tubes are in heat transferring contact with the reforming catalyst bed 70 and provide a controlled, distributed heat flux to the catalyst bed sufficient to drive the reforming reactions. While the membrane tubes and the FDC tubes are shown to be in a particular geometric pattern in FIG. 11, it is understood that other geometric arrangements of these tubes may be used and are within the scope of the invention. While “closed ended” FDC tubes are employed in the particular reactor shown in FIG. 11, “open ended” FDC tubes may be suitably employed as well. Also, the FDC tubes and/or the membrane tubes may be surrounded by cylindrical screens (not shown) to protect them from getting in direct contact with the catalyst, and allow insertion of these tubes even after the catalyst is loaded into the reactor.

The FDC chaser must be free of obstructions and have a tubular dimension for the external or exterior tube of the FDC chamber such that the length to diameter ratio is higher than a given limit, preferably more than 4. This ratio ensures that the air velocity in the chamber becomes higher than the flame velocity of the fuel and that turbulence is induced to improve heat transfer. In such a condition, no flames are created or stabilized. Any obstructions (like baffles) would create stagnation points where flames would form and stabilize.

High purity hydrogen, which diffuses through the membrane into the membrane tubes, is removed from the reactor via outlet(s) 86 together with the sweep gas (in this case steam). While outlet 86 is shown in FIG. 11 to be located on the side of the reactor, this outlet may optionally be located at the bottom of the reactor thereby avoiding a bottom side exit manifold. A further option involves the use of a vacuum instead of a sweep gas to facilitate diffusion of the hydrogen through the membrane into the membrane tubes. Vacuum can be induced either mechanically with a pump or chemically with a metal hydride precursor which reacts away the hydrogen to form metal hydride. The hydride is on-line for a given period of time and when it is saturated, a parallel compartment can be put on-line, while the original compartment is isolated and heated to desorb and produce the hydrogen. This is advantageous in cases where the hydrogen needs to be stored and/or shipped to a customer or in cases where the cost of electrical energy for running a pump is higher than using waste energy to desorb the hydrogen from the hydride. Detailed economics will dictate the right choice.

In another embodiment of the reactor in FIG. 11, the sweep gas inlet 85 and the hydrogen, sweep gas outlet 86 and their associated plenums, may be placed on the top of the reactor allowing easy access to the bottom of the reactor. In a further embodiment of the reactor of FIG. 11, the preheated air inlet 76, the fuel inlet 77 and the flue gas outlet 80 and their associated plenums may be placed on the bottom of the reactor allowing easy access to the top of the reactor.

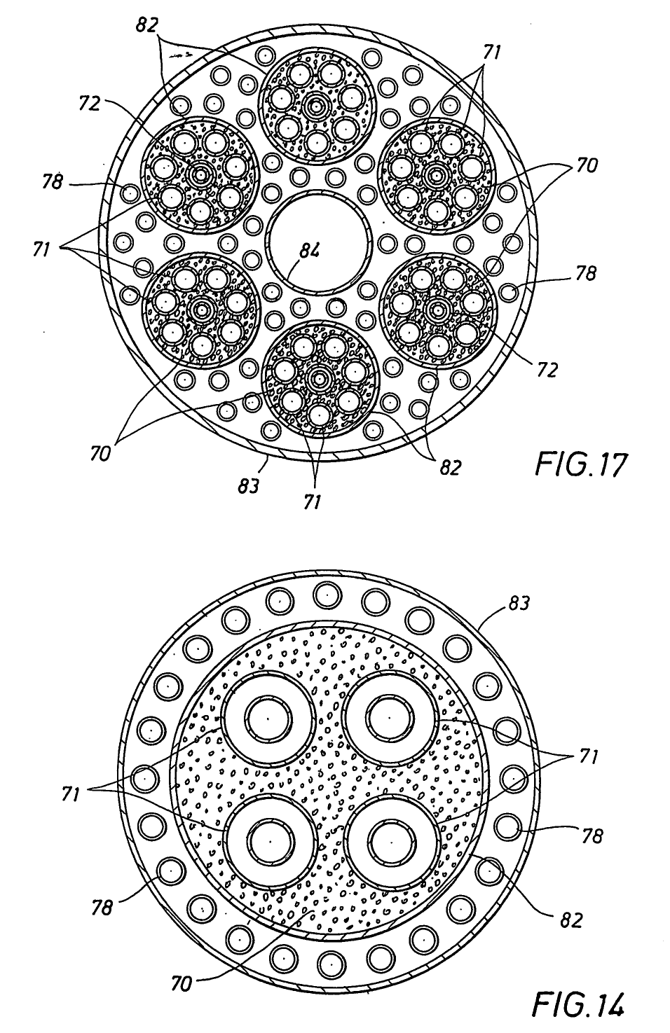

By-product gases, including carbon dioxide, steam, and minor amounts of carbon monoxide and unpermeated hydrogen, if not further used internally for heat production, e.g., combustion or heat exchange, exit the multi-tubular, axial flow, reactor via outlet 74. The reactor shown in FIG. 11 may be equipped with baffles and/or screens such as the baffles shown in FIGS. 13A and 13B or 13C and 13D.

### ILLUSTRATIVE EMBODIMENT 5

FIG. 12 is a top cross-section view of the shell of the multi-tubular, FDC heated, axial flow, membrane reactor shown in FIG. 11. In the embodiment shown multiple membrane tubes 71 and multiple FDC tubes 72 are dispersed in reforming catalyst bed 70. The multiple FDC tubes employed in this embodiment are “closed ended” FDC tubes as discussed above in connection with FIG. 11. The membrane tubes are equipped with an outer sweep gas feed tube and an inner hydrogen, sweep gas return tube as discussed in connection with FIG. 11. A typical reactor of the type shown in this FIG. 12 may comprise, for example, 19 FDC tubes of 5.5″ OD and 90 membrane tubes of 2″ OD enclosed in a shell of 3.5 ft diameter containing catalyst in the void spaces. Other shell sizes and numbers of tubes can be suitably employed depending on the capacity needed. The design parameter which is of outmost importance is the optimum gap between the membrane and the FDC tubes. If a high gap is assumed, then heat transfer limitations occur since the flow of enthalpy from FDC to the reforming reaction is slow. The membranes may not operate isothermally and cold spots may develop, thus reducing the reactor efficiency. If a small gap is assumed, then there may be problems with insufficient catalyst penetration in the gap, overheating of the membrane, or even touching of the hot FDC tube with the membrane in conditions where the tubes are not perfectly straight. A narrow gap limitation will make reactor fabrication more expensive, since clearances are hard to achieve. Thus, an intermediate gap is more preferable. As a particular non-limiting example, the gap between the membrane and the FDC tubes is from about ¼ inch (about 0.64 cm) to about 2 inches (about 5.08 cm), particularly from about ½ inch (about 1.27 cm) to about 1 inch (about 2.54 cm). The gap between the membrane tubes may be from about ¼ inch to about 2 inches, particularly from about ½ inch to about 1 inch and this has to be also optimized. The hydrogen-permeable membrane tube has a ratio of length to diameter of less than about 500.

### ILLUSTRATIVE EMBODIMENT 6

FIGS. 13A and 13B and 13C and 13D show two different configurations of baffles which may be employed in the multi-tubular, FDC heated, axial flow, membrane steam reforming reactors of the invention to increase contact of the reactant gases with the catalyst in the catalyst beds. The baffle configuration shown in FIGS. 13A and 13B comprise a washer shaped baffle 87 and a disk shaped baffle 88 arranged in and alternating pattern. This baffle arrangement causes the feed and reactant gases to flow through the hole in the washer shaped baffle and be deflected by disk shaped baffle thereby enhancing the contact of the reactant gases with the catalyst (not shown) which is packed in the area between the baffles.

The baffle arrangement shown in FIGS. 13C and 13D comprises truncated disks 89 which are placed in and alternating pattern (truncated left and truncated right) in the reactor thereby causing the feed and reactant gases to “zigzag” as they flow through the catalyst (not shown) which is packed in the area between the baffles.

The baffles in FIGS. 13A&B and 13C&D will have openings (not shown) to allow the FDC tubes and membrane tubes to pass through them. Screens positioned in vertical alignment (not shown) may also be used to support the baffles and in some cases hold the catalyst away from the shell wall or from the center of the shell for better gas flow distribution.

### ILLUSTRATIVE EMBODIMENT 7

FIG. 14 is a top cross-section view of the shell of a multi-tubular reactor in accordance with one embodiment of the invention in which four membrane tubes 71 are dispersed in the reforming catalyst bed 70 which is packed into reactor tube 82, while the FDC chamber is in the form of an annulus surrounding the reforming catalyst bed. The tubular FDC chamber (which is defined by outer wall 83 and the wall of the reactor tube 82) contains multiple fuel conduits 78 having nozzles (not shown) through which fuel flows and mixes with preheated air flowing in the FDC chamber whereupon flameless combustion occurs. If a sweep gas is employed, the membrane tubes 71 may contain an outer sweep gas feed tube and an inner return tube for sweep gas and hydrogen as shown in FIG. 14. In one embodiment of the invention, the membrane tubes have an OD of 2 inches, while the outer FDC tube has an inner diameter (ID) of approximately 8.6 inches. However, other sizes can be suitably employed.

### ILLUSTRATIVE EMBODIMENT 8

FIG. 15 is a top cross-section view of the shell of another embodiment of the multi-tubular, axial flow, reactor of the invention in which multiple reactor tubes 82 packed with reforming catalyst are employed. In this example each of the six reactor tubes 82 contains a catalyst bed 70 and a membrane tube 71 containing an outer sweep gas feed tube and an inner hydrogen, sweep gas return tube. Heat is provided to the reforming catalyst beds by the tubular FDC chamber defined by outer wall 83 and inner wall 84. The FDC chamber contains multiple fuel conduits 78 dispersed at various intervals in the FDC chamber. A hollow tube or cylinder defined by inner wall 84 may optionally be used for flow distribution.

### ILLUSTRATIVE EMBODIMENT 9

FIG. 16 is a top cross-section view of the shell of further embodiment of the multi-tubular, axial flow, reactor of the invention in which four membrane tubes are dispersed in each of six reactor tubes 82 containing catalyst beds 70. Heat is provided to the catalyst beds by FDC chamber defined by outer wall 83 and inner wall 84. The FDC chamber contains multiple fuel conduits 78 having nozzles 79 (not shown). If a sweep gas is employed, the membrane tubes 71 may contain an outer sweep gas feed tube and an inner return tube for sweep gas and hydrogen as discussed shown and discussed above in connection with FIGS. 12 and 14. The hollow cylinder or tube defined by inner wall 84 may optionally be used for flow distribution.

### ILLUSTRATIVE EMBODIMENT 10

FIG. 17 is a top cross-section view of the shell of further embodiment of the multi-tubular, axial flow, reactor of the invention in which six membrane tubes 71 are dispersed in each of the six reactor tubes 82 packed with reforming catalyst. Heat is provided to the reforming catalyst beds by the FDC chamber defined by outer wall 83 and inner wall 84. The FDC chamber contains multiple fuel conduits 78. Additional heat may be provided to the catalyst beds by employing an FDC tube 72 in the center of each of the reactor tubes 82 as shown in FIG. 17. The hollow tube or cylinder defined by inner wall 84 may optionally be used for flow distribution.

If a sweep gas is employed, the membrane tubes 71 may contain an outer sweep gas feed tube and an inner return tube for sweep gas and hydrogen as discussed in FIG. 12.

Other illustrative embodiments include Examples 1-6 of US2003/0068269 and the description thereof is herein incorporated by reference.

The ranges and limitations provided in the instant specification and claims are those, which are believed to particularly point out and distinctly claim the instant invention. It is, however, understood that other ranges and limitations that perform substantially the same function in substantially the same manner to obtain the same or substantially the same result are intended to be within the scope of the instant inventions defined by the instant specification and claims

1. A flameless distributed combustion heated; membrane, steam reforming reactor comprising:
a) a reforming chamber containing a reforming catalyst bed, said reforming chamber having an inlet for vaporizable hydrocarbon and steam, a flow path for hydrogen and by-product gases resulting from the reforming reactions taking place in said reforming chamber and an outlet for said by-product gases,
b) at least one flameless distributed combustion chamber in a heat transferring relationship with said reforming catalyst bed whereby a distributed, controlled heat flux is provided by said flameless distributed combustion chambers(s) to said reforming catalyst bed, said flameless distributed combustion chamber(s) comprising an inlet and a flow path for an oxidant, an outlet for combustion gas and further comprising a fuel conduit having an inlet for fuel and a plurality of fuel nozzles which provide fluid communication from within the fuel conduit to the flow path of said oxidant, said plurality of fuel nozzles being sized and spaced along the length of said fuel conduit so that no flame results when said fuel is mixed with said oxidant in said flameless distributed combustion chamber;
c) a preheater capable of preheating said oxidant to a temperature that when said fuel and said oxidant are mixed in said flameless distributed combustion chamber, the temperature of the resulting mixture of said oxidant and fuel exceeds the autoignition temperature of said mixture; and
d) at least two hydrogen-selective, hydrogen-permeable, membrane tubes in contact with said reforming catalyst bed, each of said membrane tubes having an outlet whereby hydrogen formed in the reforming chamber permeates into said membrane tube and passes through said outlet.

2. A process for the production of hydrogen, comprising:
a) reacting steam with a vaporizable hydrocarbon at a temperature of from about 200° C. to about 700° C. and at a pressure of from about 1 bar to about 200 bar in a reaction zone containing a reforming catalyst to produce a mixture of primarily hydrogen and carbon dioxide, with a lesser amount of carbon monoxide;
b) providing heat to said reaction zone by employing at least one flameless distributed combustion chamber thereby driving said reaction; and
c) conducting said reaction in the vicinity of at least two hydrogen-permeable, hydrogen-selective membrane tubes, whereby hydrogen formed in said reaction zone permeates through said hydrogen selective membrane tubes and is separated from said carbon dioxide and carbon monoxide.

3. A membrane, steam reforming reactor comprising:
a) a reforming chamber containing a reforming catalyst bed, said reforming chamber having an inlet for vaporizable hydrocarbon and steam, a flow path for hydrogen and by-product gases resulting from the reforming reactions taking place in said reforming chamber and an outlet for said by-product gases,
b) at least one flameless distributed combustion chamber in a heat transferring relationship with said reforming catalyst bed, and
c) at least two hydrogen-selective, hydrogen-permeable, membrane tubes in contact with said reforming catalyst bed, wherein at least one of the membrane tubes is connected to a section containing a metal hydride precursor, and wherein the hydrogen formed in the reforming chamber permeates through said membrane tube to said section containing the metal hydride precursor which reacts with the permeated hydrogen to form hydride.

4. (canceled)

5. (canceled)

6. The hydrogen fuel cell, wherein the hydrogen feed is made by a process as described in claim 2.

7. (canceled)

8. The process of claim 2, wherein said catalyst bed is in heat transferring contact with multiple flameless distributed combustion chambers.

9. (canceled)

10. (canceled)

11. The process of claim 2, wherein a sweep gas is used to promote the diffusion of hydrogen through at least one of said membrane tubes, said sweep gas being selected from the group consisting of steam, carbon dioxide, nitrogen and condensable hydrocarbon and the vaporizable hydrocarbon is selected from the group consisting of natural gas, methane, ethyl benzene, methanol, ethane, ethanol, propane, butane, light hydrocarbons having 1-4 carbon atoms in each molecule, light petroleum fractions including naphtha, diesel, kerosene, jet fuel or gas oil, and hydrogen, carbon monoxide and mixtures thereof.

12. (canceled)

13. The reactor, of claims 1, wherein said catalyst bed contains baffles in a form selected from the group consisting of (i) washers and disks, and (ii) truncated disks.

14. The reactor, of claim 1, wherein the hydrogen-selective and at least one of the hydrogen-permeable membranes is made of a Pd-alloy layer supported on a porous metal, particularly a Pd-alloy layer deposited by electroless plating on porous metal with an in-situ oxide protection layer.

15. (canceled)

16. The reactor, of claim 1, wherein at least one of the hydrogen-selective and hydrogen-permeable membranes has a ratio of length to diameter of less than about 500, gaps between the membrane tubes are from about ¼ inch (about 0.64 cm) to about 2 inches (about 5.08 cm), and gap between the membrane and FDC tubes is from about ¼ inch (about 0.64 cm) to about 2 inches (about 5.08 cm).

17. (canceled)

18. The reactor, of claim 1, wherein the FDC chamber has an external tubular dimension such that the length to diameter ratio is higher than 4.

19. (canceled)

20. (canceled)

21. The process of claim 2, wherein carbon dioxide produced from said steam reforming chamber has a concentration of from about 80% to about 99% molar dry basis.

22. (canceled)

23. The process of claim 2, wherein carbon dioxide produced from said steam reforming chamber is used at least in part for enhanced recovery of oil in oil wells or enhanced recovery of methane in coal bed methane formations.

24. The reactor of claim 1, wherein said catalyst bed is in heat transferring contact with multiple flameless distributed combustion chambers.

25. The reactor of claim 3, wherein said catalyst bed is in heat transferring contact with multiple flameless distributed combustion chambers.

26. The reactor of claim 3, wherein a sweep gas is used to promote the diffusion of hydrogen through at least one of said membrane tubes, said sweep gas being selected from the group consisting of steam, carbon dioxide, nitrogen and condensable hydrocarbon and the vaporizable hydrocarbon is selected from the group consisting of natural gas, methane, ethyl benzene, methanol, ethane, ethanol, propane, butane, light hydrocarbons having 1-4 carbon atoms in each molecule, light petroleum fractions including naphtha, diesel, kerosene, jet fuel or gas oil, and hydrogen, carbon monoxide and mixtures thereof.

27. The reactor of claim 3, wherein said catalyst bed contains baffles in a form selected from the group consisting of (i) washers and disks, and (ii) truncated disks.

28. The reactor of claim 3, wherein the hydrogen-selective and at least one of the hydrogen-permeable membranes is made of a Pd-alloy layer supported on a porous metal, particularly a Pd-alloy layer deposited by electroless plating on porous metal with an in-situ oxide protection layer.

29. The reactor of claim 3, wherein at least one of the hydrogen-selective and hydrogen-permeable membranes has a ratio of length to diameter of less than about 500, gaps between the membrane tubes are from about 14 inch (about 0.64 cm) to about 2 inches (about 5.08 cm), and gap between the membrane and FDC tubes is from about 14 inch (about 0.64 cm) to about 2 inches (about 5.08 cm).

30. The reactor of claim 3, wherein the FDC chamber has an external tubular dimension such that the length to diameter ratio is higher than 4.
